(19) United States
(12) Patent Application Publication
(10) Pub. No.: US 2019/0129190 A1
(43) Pub. Date: May 2, 2019

(54) LIQUID CRYSTAL LENS AND 3D DISPLAYING DEVICE

(71) Applicant: Wuhan China Star Optoelectronics Technology Co., Ltd., Wuhan, Hubei (CN)

(72) Inventor: Guowei ZHA, Wuhan, Hubei (CN)

(21) Appl. No.: 15/578,492

(22) PCT Filed: Nov. 23, 2017
(86) PCT No.: PCT/CN2017/112568

§ 371 Date: Aug. 23, 2018

(30) Foreign Application Priority Data
Oct. 31, 2017 (CN) 201711049637.X

(51) Int. Cl. G02B 27/22; G02F 1/29

(52) U.S. Cl. CPC G02B 27/2214; G02F 1/29; G02F 2202/108; G02F 2202/06; G02F 2001/294

(57) ABSTRACT

A liquid crystal lens and a 3D displaying device are provided. The liquid crystal lens comprises a first substrate and a second substrate, first electrodes on the first substrate, second electrodes on the second substrate, and a liquid crystal unit between the first and the second electrodes. A liquid crystal material in the liquid crystal unit is doped with a quantum dot material for transforming a portion of a first color light entering the liquid crystal unit to a second color light and a third color light, and a combination of the first, the second and the third color lights is white light. The 3D displaying device comprises a 2D displaying device and the liquid crystal lens stacked on a light output surface thereof. The liquid crystal lens is same as described above, and a light output from the 2D displaying device is the first color light.

### RELATED APPLICATIONS

The present application is a National Phase of International Application Number PCT/CN2017/112568, filed December 23, 2017, and claims the priority of China Application 201711049637.X, filed Oct. 31, 2017.

### FIELD OF THE DISCLOSURE

The disclosure relates to a display technical field, and more particularly, to a liquid crystal lens and a 3D displaying device.

### BACKGROUND

High color gamut of displaying devices are widely favored by consumers due to the ability to perform more colors of the natural world, high color saturation and color reproducibility. The current technology for achieving high color gamut is basing on the quantum dot (QD) technology including quantum dot thin films, quantum dot tubes, etc. Among these technologies, the quantum dot thin films have become the best choice for thinning display. For example, in the conventional 2D (two dimensions) displaying device, the quantum dot thin films usually are disposed on the light output surface of the backlight module, and the quantum dot thin films could transform blue light emitted from the backlight module to white light for the liquid crystal panel.

In 3D (three dimensions) displaying technology, when a user watches an image, different lights for appearing the same image enter separately into the user's left eye and right eye. The different lights would form the images with minor differences in the user's left eye and right eye individually, for simulating the images with minor differences observed by the user's eyes when the user watches a 3D object, thereby to achieve the 3D displaying.

In current technology, for achieving the 3D displaying purpose, a liquid crystal lens is usually stacked on the light output surface of liquid crystal displaying device. The liquid crystal displaying device is a conventional 2D liquid crystal displaying device. The liquid crystal lens includes multiple liquid repeating units, each liquid repeating unit is equivalent to a columnar lens. When the light for appearing same image pass through the liquid crystal lens, each liquid repeating unit would have the light focus on different directions, thereby to have the light entering the user's left eye and right eye be different. In specific, the liquid crystal lens includes an upper substrate and a lower substrate disposed relatively to each other, and a liquid crystal layer disposed between the upper substrate and the lower substrate. The upper substrate is fabricated with upper electrodes thereon, and the lower substrate is fabricated with multiple bar electrodes arranged in parallel to each other. When the bar electrodes are charged to form an electrical field between the upper electrodes and the bar electrodes, the inclined angles of the liquid crystal molecules in the liquid crystal layer near the lower substrate will decrease gradually from center area to peripheral area, thereby to make the refractive index of the liquid crystal molecules in the liquid crystal layer near the lower substrate be decreasing gradually from center area to peripheral area. The change of the refractive index makes the light passing through the liquid crystal layer near the lower substrate be focused on a predetermined direction. Through the optical effect of the multiple liquid crystal repeating units in the liquid crystal lens, the 3D displaying can be fulfilled.

Compared to the conventional 2D displaying device, the 3D displaying device basing on the liquid crystal lens increases inevitably the thickness of the displaying module. The quantum dot thin films applied in the 2D displaying device also increases the thickness of the displaying module. The stack thickness due to the above two technologies would be a great hurdle for the thinning process of 3D displaying device. Besides, in the technology of high color gamut quantum dot, the luminous efficiency of quantum dot backlight is far lower than that of conventional low color gamut displaying module, because the green light with large contribution to brightness has smaller line width. Further, the design of 3D displaying technology basing on the liquid crystal lens is to deliver the image signals of different viewpoints to different eyes, which also cause the brightness of 3D displaying module to be lower than that of the conventional 2D displaying module. Apparently, the above issues of thickness and brightness still are the great hurdle for the further breakthroughs of high color gamut displaying technology.

### SUMMARY

In view of this, the present invention provides a liquid crystal lens and a 3D displaying device, for promoting displaying gamut and brightness of the 3D displaying device and considering the development trend of thinning the 3D displaying device simultaneously.

For achieving the above purpose, the following technical solution is used in the present invention.

A liquid crystal lens comprises a first substrate and a second substrate disposed relatively to each other, first electrodes disposed on the first substrate, second electrodes disposed on the second substrate, and a liquid crystal unit disposed between the first electrodes and the second electrodes; wherein, a liquid crystal material in the liquid crystal unit is doped with a quantum dot material, and the quantum dot material is applied to transform a portion of a first color light entering the liquid crystal unit to a second color light and a third color light, and a combination of the first color light, the second color light and the third color light is white light.

In one embodiment, a plurality of isolators are disposed between the first substrate and the second substrate, the plurality of isolators are applied to divide the liquid crystal unit into an array of a first liquid crystal lens unit, a second liquid crystal lens unit and a third liquid crystal lens unit; wherein the liquid crystal material in the first liquid crystal lens unit is not doped with the quantum dot material, and the first color light entering the first liquid crystal lens unit is maintained as the first color light; wherein the liquid crystal material in the second liquid crystal lens unit is doped with the quantum dot material corresponding to the second color light, and the first color light entering the second liquid crystal lens unit is transformed to the second color light; wherein the liquid crystal material in the third liquid crystal lens unit is doped with the quantum dot material corresponding to the third color light, and the first color light entering the third liquid crystal lens unit is transformed to the third color light.

In one embodiment, the quantum dot material includes a red quantum dot material and a green quantum dot material, and the first color light is blue light, the second color light is red light, and the third color light is green light; the red quantum dot material and the green quantum dot material are applied to transform the portion of the blue light entering the liquid crystal unit to red light and green light separately.

In one embodiment, each of the first liquid crystal lens unit, the second liquid lens crystal unit and the third liquid lens crystal unit includes at least two the first electrodes individually.

In one embodiment, the liquid crystal unit is a continuous layer in parallel to the first substrate and the second substrate, and the quantum dot material is evenly doped into the liquid crystal unit; wherein, the second substrate includes a color resist film disposed thereon, and the color resist film includes an array of a first color photoresist unit, a second color photoresist unit and a third color photoresist unit.

In one embodiment, the color resist film is disposed between the second substrate and the second electrodes

The present invention also provides a 3D displaying device, comprising a 2D displaying device and the liquid crystal lens stacked on a light output surface of the 2D displaying device, wherein the liquid crystal lens is same as described above, and a light output from the 2D displaying device for displaying is the first color light.

In one embodiment, the 2D displaying device comprises a backlight module and a liquid crystal panel disposed relatively to each other, and the liquid crystal lens is stacked on a light output surface of the liquid crystal panel. A backlight illumination provided by the backlight module is the first color light, the liquid crystal panel receives the first color light and outputs the light through the light output surface thereof for displaying, wherein the light is maintained as the first color light.

In one embodiment, the liquid crystal panel comprises a lower polarizer, a TFT array substrate, an opposing substrate and an upper polarizer, and a liquid crystal layer is disposed between the TFT array substrate and the opposing substrate.

In one embodiment, the opposing substrate of the liquid crystal panel and the first substrate of the liquid crystal lens share a common substrate.

The liquid crystal lens and the 3D displaying device provided by the present invention can satisfy the requirements of high color gamut of 3D displaying device, by doping the quantum dot material into the liquid crystal unit of the liquid crystal lens and using the quantum dot technology to promote the color gamut of the 3D displaying device, Besides, the quantum dot material is disposed in the liquid crystal unit of the liquid crystal lens, so there is no need to add an additional structure layer of quantum dot film, which is beneficial to thinning development of the 3D displaying device. Further, in the liquid crystal lens, the liquid crystal unit usually has a thicker cell gap for getting a better effect of phase delay. Therefore, disposing the quantum dot material in the liquid crystal unit would have longer conversion paths to transform the light more fully. For example, the incident blue light can be transformed to the green light more fully, thereby to promote the brightness of the 3D displaying device.

Furthermore, the disclosure further provides a display device including the display panel.

### BRIEF DESCRIPTION OF THE DRAWINGS

FIG. 1 is a structure scheme view of the liquid crystal lens provided by the first embodiment of the present invention;

FIG. 2 is a structure scheme view of the 3D displaying device provided by the first embodiment of the present invention;

FIG. 3 is a structure scheme view of the 3D displaying device provided by the second embodiment of the present invention;

FIG. 4 is a structure scheme view of the liquid crystal lens provided by the third embodiment of the present invention;

FIG. 5 is a structure scheme view of the 3D displaying device provided by the third embodiment of the present invention; and

FIG. 6 is a structure scheme view of the 3D displaying device provided by the first embodiment of the present invention.

### DETAILED DESCRIPTION OF PREFERRED EMBODIMENTS

In order to make the purpose, technical scheme and advantages of the present invention more clear and obvious, the present invention will be further illustrated in detail in combination with accompanying drawings and embodiments hereinafter. The specific structural and functional details disclosed herein are only representative and are intended for describing exemplary embodiments of the disclosure. However, the disclosure can be embodied in many forms of substitution, and should not be interpreted as merely limited to the embodiments described herein.

It should be noted, for avoiding unnecessary details obscuring the present invention, in the drawings and description only the structures and/or processing steps closely related to the scheme of the present invention are illustrated, and other details not directly related to the present invention are omitted.

### First Embodiment

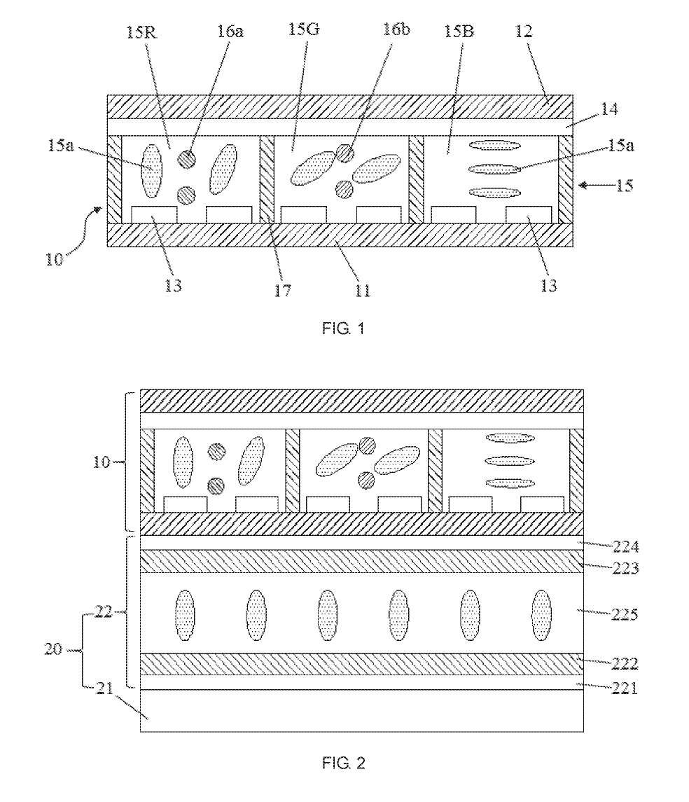

In this embodiment, a liquid crystal lens is provided, As shown in FIG. 1, the liquid crystal lens 10 comprises a first substrate 11 and a second substrate 12 disposed relatively to each other, first electrodes 13 disposed on the first substrate 11, second electrodes 14 disposed on the second substrate 12, and a liquid crystal unit 15 disposed between the first electrodes 13 and the second electrodes 14.

When the liquid crystal lens 10 is applied for 3D displaying, the liquid crystal unit 15 can be fabricated to be an array of liquid crystal lens units. When the first electrodes 13 are charged, an electrical field is formed between the first electrodes 13 and the second electrodes 14, to have liquid crystal molecules incline in different directions. The refractive index of this area would evenly increase from center to two edges, thereby to cause the light to be refracted to approximately the same direction, namely the light to be focused, when the light passing through the area with evenly altering refractive index. Therefore, the liquid crystal lens 10 is disposed in the 3D displaying devices, and the different liquid crystal lens 10 can have the different light, for appearing the same image, be focused on an observer's left eye and right eye individually, thereby to form the images with minor difference separately in the observer's left eye and right eye, which result in an illusion occurring in the observer's brain, to recognize the image as a three dimensional picture, for finally fulfilling the 3D displaying.

In an embodiment, a liquid crystal material 15a in the liquid crystal unit 15 is doped with a quantum dot material. The quantum dot material is applied to transform a portion of a first color light entering the liquid crystal unit 15 to a second color light and a third color light, and a combination of the first color light, the second color light and the third color light is white light. For example, the quantum dot material includes a red quantum dot material 16a and a green quantum dot material 16b, and the first color light is blue light, the second color light is red light, and the third color light is green light. The red quantum dot material 16a and the green quantum dot material 16b are applied to transform the portion of the blue light entering the liquid crystal unit 15 to red light and green light separately. The transformed red light and green light and other portion of the blue light not transformed could be combined into the white light.

In this embodiment, as shown in FIG. 1, a plurality of isolators 17 are disposed between the first substrate 11 and the second substrate 12. The plurality of isolators 17 are applied to divide the liquid crystal unit 15 into an array of a first liquid crystal lens unit 15B, a second liquid crystal lens unit 15R and a third liquid crystal lens unit 15G. Each of the first liquid crystal lens unit 15B, the second liquid crystal lens unit 15R and the third liquid crystal lens unit 15G includes at least two the first electrodes individually. It should be noted, FIG. 1 only illustrates exemplarily one first liquid crystal lens unit 15B, one second liquid crystal lens unit 15R and one third liquid crystal lens unit 15G. Each of the first liquid crystal lens unit 15B, the second liquid crystal lens unit 15R and the third liquid crystal lens unit 15G includes at least two the first electrodes 13 individually.

In an embodiment, the liquid crystal material 15a in the first liquid crystal lens unit 15B is not doped with the quantum dot material, and the first color light entering the first liquid crystal lens unit 15B is maintained as the first color light. In specific, the color of blue light entering the first liquid crystal lens unit 15B would not be changed and be maintained as the blue light after passing through the first liquid crystal lens unit 15B.

In an embodiment, the liquid crystal material 15a in the second liquid crystal lens unit 15R is doped with the quantum dot material corresponding to the second color light, and the first color light entering the second liquid crystal lens unit 15R is transformed to the second color light. In specific, the liquid crystal material 15a in the second liquid crystal lens unit 15R is doped with the red quantum dot material 16a, so the color of blue light entering the second liquid crystal lens unit 15R would be transformed to the red light.

The liquid crystal material 15a in the third liquid crystal lens unit 15G is doped with the quantum dot material corresponding to the third color light, and the first color light entering the third liquid crystal lens unit 15G is transformed to the third color light. In specific, the liquid crystal material 15a in the third liquid crystal lens unit 15G is doped with the green quantum dot material 16b, so the color of blue light entering the third liquid crystal lens unit 15G would be transformed to the green light.

In an embodiment, glass substrates are chosen to form the first substrate 11 and the second substrate 12, and transparent conducting material, such as indium tin oxide (ITO), is chosen to form the first electrodes 13 and the second electrodes 14. The quantum dot material usually applied in the display technology can be chosen to form the quantum dot material herein. The quantum dot material and the liquid crystal molecules are injected into the liquid crystal box formed by the first substrate 11 and the second substrate 12.

The present invention also provides a 3D displaying device, as shown in FIG. 2. The 3D displaying device comprises a 2D displaying device 20 and the liquid crystal lens 10 stacked on a light output surface of the 2D displaying device 20. The liquid crystal lens 10 is same as described in above embodiment, and the light output from the 2D displaying device 20 for displaying is the first color light. In specific, the first color light is blue light.

In this embodiment, the 2D displaying device 20, as shown in FIG. 2, is a liquid crystal display device, and comprises a backlight module 21 and a liquid crystal panel 22 disposed relatively to each other. The liquid crystal lens 10 is stacked on a light output surface of the liquid crystal panel 22. The liquid crystal lens 10 can be attached on the light output surface of the liquid crystal panel 22 by an adhesive layer. A backlight illumination provided by the backlight module 21 is the first color light. For example, the backlight module 21 is a backlight module 21 of blue light. The liquid crystal panel 22 receives the first color light and outputs the light through the light output surface thereof for displaying. The light is maintained as the first color light.

The backlight module 21 could be a side entry type backlight module or a direct type backlight module. The liquid crystal panel 22 can be any one conventional liquid crystal panel. However, it is necessary to remove the color resist layer from the conventional liquid crystal panel. Thus, after the liquid crystal panel receives the first color light and outputs the light through the light output surface thereof for displaying, the light is still maintained as the first color light. As a specific example, as shown in FIG. 2, the liquid crystal panel 22 comprises a lower polarizer 221, a TFT array substrate 222, an opposing substrate 223 and an upper polarizer 224, and a liquid crystal layer 225 is disposed between the TFT array substrate 222 and the opposing substrate 223. Compared to the color resist substrate in conventional liquid crystal panel, only the structure layer with photoresist function is removed in the opposing substrate 223.

More details of the liquid crystal lens and the 3D displaying device provided in above embodiments are depicted as follows.

At first, the 3D displaying device with high color gamut can be fulfilled by doping the quantum dot material into the liquid crystal unit 15 of the liquid crystal lens 10 and using the quantum dot technology to promote the color gamut of the 3D displaying device.

Second, the quantum dot material is disposed in the liquid crystal unit 15 of the liquid crystal lens 10, so there is no need to add an additional structure layer of quantum dot film, which is beneficial to thinning development of the 3D displaying device. On the contrary, in current technology, an additional quantum dot film is usually added to the 2D displaying device 20.

Besides, the liquid crystal unit 15 is divided by the isolators 17 into the first liquid crystal lens unit 15B corresponding to blue light, the second liquid crystal lens unit 15R corresponding to red light and the third liquid crystal lens unit 15G corresponding to green light, so the structure layer of photoresist function is removed from the 2D displaying device 20, thereby to decrease the thickness of the 3D displaying device.

Further, in the liquid crystal lens 10, the liquid crystal unit 15 usually has a thicker cell gap and is larger than 30 μm, to get a better effect of phase delay. Therefore, disposing the quantum dot material in the liquid crystal unit 15 would have longer conversion paths to transform the light more fully and does not take up extra thickness. For example, the incident blue light can be transformed to the green light more fully, thereby to promote the brightness of the 3D displaying device.

### Second Embodiment

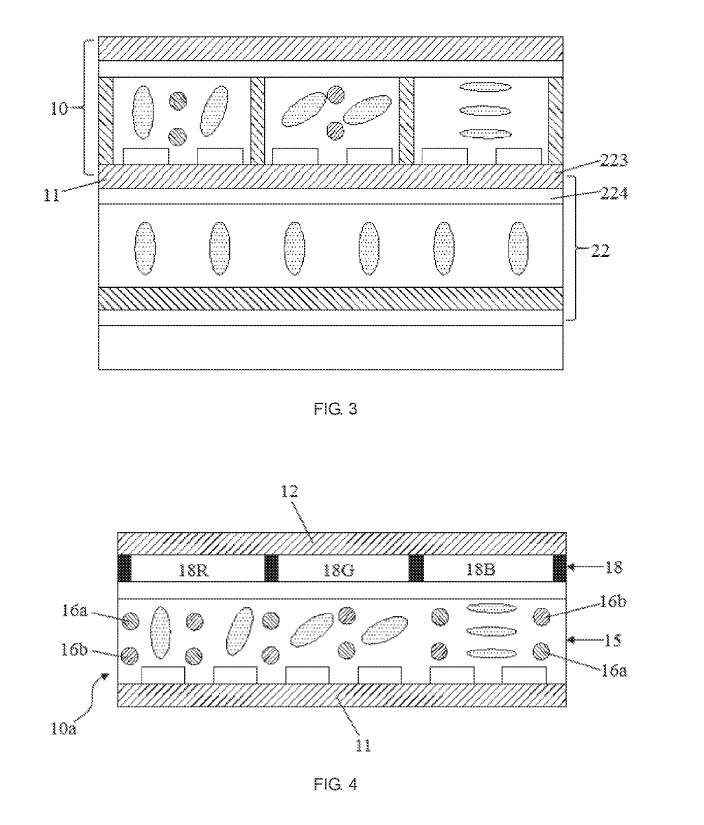

A 3D displaying device is provided in this embodiment. Different with the 3D displaying device provided in the first embodiment, as shown in FIG. 3, in this embodiment, the opposing substrate 223 of the liquid crystal panel 22 and the first substrate 11 of the liquid crystal lens 10 share a common substrate. The other structures of the 3D displaying device provided in this embodiment are same as that of the 3D displaying device provided in the first embodiment, not repeat here.

Referring to FIG. 3, each structure layer formed on the first substrate 11 in the liquid crystal lens 10 is formed on a first surface of the common substrate 11, 223, and each structure layer formed on the second substrate 223 in the liquid crystal panel 22 is formed on a second surface, opposite to the first surface, of the common substrate 11, 223. The upper polarizer 224 can be disposed on the first surface or the second surface of the common substrate 11, 223.

Compared to the 3D displaying device in the first embodiment, the liquid crystal lens 10 and the liquid crystal panel 22 of the 3D displaying device in this embodiment share a common substrate, thereby to decrease the thickness of the 3D displaying device and be beneficial for the thinning development of the 3D displaying device.

### Third Embodiment

In this embodiment, a liquid crystal lens is provided. Different with the liquid crystal lens 10 provided in the first embodiment, as shown in FIG. 4, in the liquid crystal lens 10a, there is no isolator disposed between the first substrate 11 and the second substrate 12. Namely, the liquid crystal unit 15 is a continuous layer in parallel to the first substrate 11 and the second substrate 12, and the red quantum dot material 16a and the green quantum dot material 16b are evenly doped into the liquid crystal unit 15. Further, the second substrate 12 includes a color resist film 18 disposed thereon. The color resist film 18 includes an array of a first color photoresist unit 18B, a second color photoresist unit 18R and a third color photoresist unit 18G. Each of the first color photoresist unit 18B, the second color photoresist unit 18R and the third color photoresist unit 18G corresponds to a sub pixel. In specific, the first color photoresist unit 18B is a blue photoresist unit, the second color photoresist unit 18R is a red photoresist unit and the third color photoresist unit 18G is a green photoresist unit. The blue light passing through the liquid crystal unit 15 is transformed to white light, and then the white light passing through the color resist film 18 is divided into the red light, the green light and the blue light. Further, in this embodiment, the color resist film 18 is disposed between the second substrate 12 and the second electrodes 14.

The other structures of the liquid crystal lens provided in this embodiment are same as that of the liquid crystal lens provided in the first embodiment, not repeat here. Compared to the liquid crystal lens in the first embodiment, the thickness of the liquid crystal lens 10a is increasing slightly due to adding the color resist film 18, however, the process difficulty of manufacturing is reduced greatly due to cancelling the isolators between the first substrate 11 and the second substrate 12.

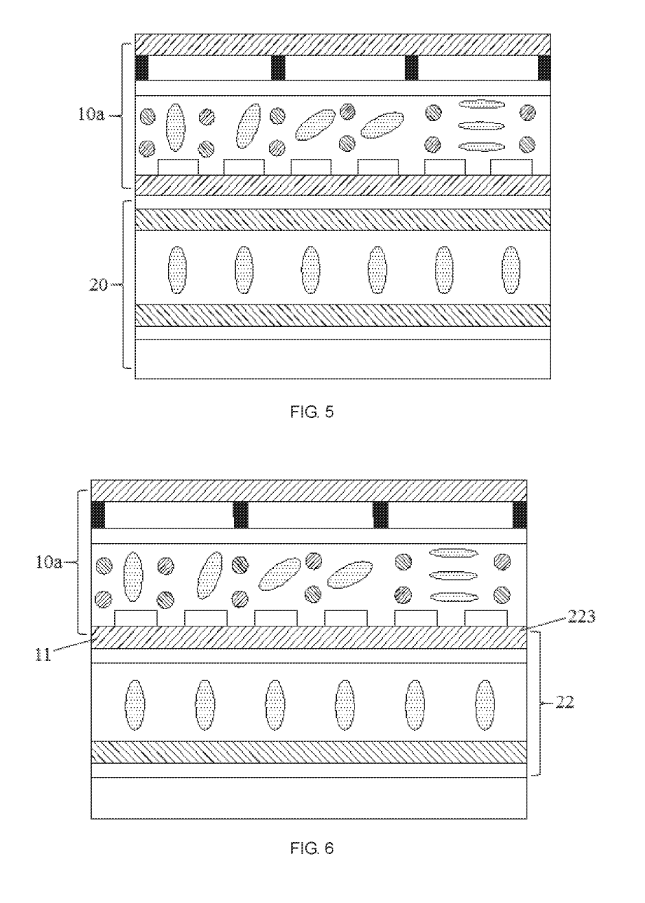

This embodiment also provides a 3D displaying device. As shown in FIG. 5, the 3D displaying device comprises a 2D displaying device 20 and the liquid crystal lens 10a stacked on a light output surface of the 2D displaying device 20. The liquid crystal lens 10a is provided by this embodiment. The other specific structures of the 2D displaying device 20 are same as that in the first embodiment, not repeat here.

The technical effect of the liquid crystal lens and the 3D displaying device of this embodiment is similar to the technical effect of the liquid crystal lens and the 3D displaying device of the first embodiment. The difference is, as described above, in this embodiment, the thickness is increasing slightly due to adding the color resist film 17, however, the process difficulty of manufacturing is reduced greatly due to cancelling the isolators between the first substrate 11 and the second substrate 12

### Fourth Embodiment

This embodiment provides a 3D displaying device. Compared to the 3D displaying device in the third embodiment, in this embodiment, as shown in FIG. 6, referring to the scheme in the second embodiment, the opposing substrate 223 of the liquid crystal panel 22 and the first substrate 11 of the liquid crystal lens 10a share the common substrate. The other structures of the 3D displaying device provided in this embodiment are same as that of the 3D displaying device provided in the first embodiment, not repeat here.

Compared to the 3D displaying device in the third embodiment, the liquid crystal lens 10a and the liquid crystal panel 22 of the 3D displaying device in this embodiment share a common substrate, thereby to decrease the thickness of the 3D displaying device and to be beneficial for the thinning development of the 3D displaying device.

In conclusion, the liquid crystal lens and the 3D displaying device provided in the embodiments of the present invention can promote displaying gamut and brightness of the 3D displaying device and consider the development trend of thinning the 3D displaying device simultaneously.

It should be noted that, in this disclosure, relational terms, such as first and second, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

The foregoing contents are detailed description of the disclosure in conjunction with specific preferred embodiments and concrete embodiments of the disclosure are not limited to these descriptions. For the person skilled in the art of the disclosure, without departing from the concept of the disclosure, simple deductions or substitutions can be made and should be included in the protection scope of the application.

What is claimed is:

1. A liquid crystal lens, comprising a first substrate and a second substrate disposed relatively to each other, first electrodes disposed on the first substrate, second electrodes disposed on the second substrate, and a liquid crystal unit disposed between the first electrodes and the second electrodes; wherein, a liquid crystal material in the liquid crystal unit is doped with a quantum dot material, and the quantum dot material is applied to transform a portion of a first color light entering the liquid crystal unit to a second color light and a third color light, and a combination of the first color light, the second color light and the third color light is white light.

2. The liquid crystal lens according to claim 1, wherein a plurality of isolators are disposed between the first substrate and the second substrate, the plurality of isolators are applied to divide the liquid crystal unit into an array of a first liquid crystal lens unit, a second liquid crystal lens unit and a third liquid crystal lens unit; wherein the liquid crystal material in the first liquid crystal lens unit is not doped with the quantum dot material, and the first color light entering the first liquid crystal lens unit is maintained as the first color light; wherein the liquid crystal material in the second liquid crystal lens unit is doped with the quantum dot material corresponding to the second color light, and the first color light entering the second liquid crystal lens unit is transformed to the second color light; wherein the liquid crystal material in the third liquid crystal lens unit is doped with the quantum dot material corresponding to the third color light, and the first color light entering the third liquid crystal lens unit is transformed to the third color light.

3. The liquid crystal lens according to claim 2, wherein, the quantum dot material includes a red quantum dot material and a green quantum dot material, and the first color light is blue light, the second color light is red light, and the third color light is green light; the red quantum dot material and the green quantum dot material are applied to transform the portion of the blue light entering the liquid crystal unit to red light and green light separately.

4. The liquid crystal lens according to claim 2, wherein, each of the first liquid crystal lens unit, the second liquid crystal lens unit and the third liquid crystal lens unit includes at least two the first electrodes individually.

5. The liquid crystal lens according to claim 1, wherein, the liquid crystal unit is a continuous layer in parallel to the first substrate and the second substrate, and the quantum dot material is evenly doped into the liquid crystal unit; wherein, the second substrate includes a color resist film disposed thereon, and the color resist film includes an array of a first color photoresist unit, a second color photoresist unit and a third color photoresist unit.

6. The liquid crystal lens according to claim 5, wherein, the quantum dot material includes a red quantum dot material and a green quantum dot material, and the first color light is blue light, the second color light is red light, and the third color light is green light; the red quantum dot material and the green quantum dot material are applied to transform the portion of the blue light entering the liquid crystal unit to red light and green light separately.

7. The liquid crystal lens according to claim 5, wherein the color resist film is disposed between the second substrate and the second electrodes.

8. A 3D displaying device, comprising a 2D displaying device and a liquid crystal lens stacked on a light output surface of the 2D displaying device, wherein the liquid crystal lens comprises a first substrate and a second substrate disposed relatively to each other, first electrodes disposed on the first substrate, second electrodes disposed on the second substrate, and a liquid crystal unit disposed between the first electrodes and the second electrodes; wherein, a liquid crystal material in the liquid crystal unit is doped with a quantum dot material, and the quantum dot material is applied to transform a portion of a first color light entering the liquid crystal unit to a second color light and a third color light, and a combination of the first color light, the second color light and the third color light is white light, and a light output from the 2D displaying device for displaying is the first color light.

9. The 3D displaying device according to claim 8, wherein, the 2D displaying device comprises a backlight module and a liquid crystal panel disposed relatively to each other, and the liquid crystal lens is stacked on a light output surface of the liquid crystal panel, wherein a backlight illumination provided by the backlight module is the first color light, the liquid crystal panel receives the first color light and outputs the light through the light output surface thereof for displaying, wherein the light is maintained as the first color light.

10. The 3D displaying device according to claim 9, wherein, the liquid crystal panel comprises a lower polarizer, a TFT array substrate, an opposing substrate and an upper polarizer, and a liquid crystal layer is disposed between the TFT array substrate and the opposing substrate.

11. The 3D displaying device according to claim 10, wherein, the opposing substrate of the liquid crystal panel and the first substrate of the liquid crystal lens share a common substrate.

12. The 3D displaying device according to claim 8, wherein, a plurality of isolators are disposed between the first substrate and the second substrate, the plurality of isolators are applied to divide the liquid crystal unit into an array of a first liquid crystal lens unit, a second liquid crystal lens unit and a third liquid crystal lens unit; wherein the liquid crystal material in the first liquid crystal lens unit is not doped with the quantum dot material, and the first color light entering the first liquid crystal lens unit is maintained as the first color light; wherein the liquid crystal material in the second liquid crystal lens unit is doped with the quantum dot material corresponding to the second color light, and the first color light entering the second liquid crystal lens unit is transformed to the second color light; wherein the liquid crystal material in the third liquid crystal lens unit is doped with the quantum dot material corresponding to the third color light, and the first color light entering the third liquid crystal lens unit is transformed to the third color light.

13. The 3D displaying device according to claim 12, wherein, the quantum dot material includes a red quantum dot material and a green quantum dot material, and the first color light is blue light, the second color light is red light, and the third color light is green light; the red quantum dot material and the green quantum dot material are applied to transform the portion of the blue light entering the liquid crystal unit to red light and green light separately.

14. The 3D displaying device according to claim 12, wherein, each of the first liquid crystal lens unit, the second liquid crystal lens unit and the third liquid crystal lens unit includes at least two the first electrodes individually.

15. The 3D displaying device according to claim 8, wherein, the liquid crystal unit is a continuous layer in parallel to the first substrate and the second substrate, and the quantum dot material is evenly doped into the liquid crystal unit; wherein, the second substrate includes a color resist film disposed thereon, and the color resist film includes an array of a first color photoresist unit, a second color photoresist unit and a third color photoresist unit.

16. The 3D displaying device according to claim 15, wherein, the quantum dot material includes a red quantum dot material and a green quantum dot material, and the first color light is blue light, the second color light is red light, and the third color light is green light; the red quantum dot material and the green quantum dot material are applied to transform the portion of the blue light entering the liquid crystal unit to red light and green light separately.

17. The 3D displaying device according to claim 15, wherein the color resist film is disposed between the second substrate and the second electrodes.
